(19) United States
(12) Patent Application Publication
(10) Pub. No.: US 2026/0369140 A1
(43) Pub. Date: Nov. 19, 2026

(54) Ratchet / Security Device, Methods of Using and Making, Products, and Necessary Intermediates

(71) Applicant: Hangzhou Timing Security Technologies Co., Ltd., Hangzhou PRC (CN)

(72) Inventors: Hexiao Wang, Hangzhou PRC (CN); Peter Morello, SR., Stuart, FL (US); Peter A. Morello, JR., Stuart, FL (US); Lin Wang, Hangzhou PRC (CN)

(21) Appl. No.: 19/656,560

(22) Filed: Apr. 23, 2026

Related U.S. Application Data
(60) Provisional application No. 63/794,890, filed on Apr. 25, 2025.

(51) Int. Cl. G08B 13/14; E05B 73/00; G08B 13/24

(52) U.S. Cl. CPC G08B 13/1463; E05B 73/0029; G08B 13/1454; G08B 13/2434

(57) ABSTRACT

A method, and corresponding device, including tightening an end of a member to a position beyond a ratchet; engaging the ratchet with the member to hold the member in place with ratchet contact after the tightening; and releasably locating a conductive area of the member to integrate into a circuit of a security device comprising a battery and an alarm and thereby, when the security device is ON, trigger the alarm when the circuit comprising the conductive area of the member is disrupted.

The present patent application incorporates by reference as if fully stated herein and claims priority from U.S. Provisional Patent Application Ser. No. 63/794,890, filed Apr. 25, 2025, pending, and incorporates by reference completely as if restated totally herein U.S. Pat. No. 11,322,005, issued May 3, 2022, and U.S. Pat. No. 12,243,401, issued Mar. 4, 2025.

### I. Background

Spider wrap anti-theft devices are retractable cable alarms seen wrapped tightly around goods like electronics and boxed merchandise. While they can be effective in deterring theft, they come with several drawbacks for both consumers and retailers:

### A. Damage to Products

Tight cables can crush packaging or even the product itself (especially on boxes with softer cardboard or fragile contents). Crushing can be particularly notable for soft goods, such as blankets and pillows. This makes the goods less appealing to customers and can lead to increased returns or unsellable stock.

### B. Frustrating for Shoppers

Customers may have trouble handling or examining the product due to the bulky device. This can create a negative shopping experience—potential purchasers may abandon purchases rather than ask for staff help to remove the spider wrap. Impulse buyers may walk away if accessing the product is a hassle.

### C. Slows Down Checkout

Removing spider wraps often requires a manager or a special tool, which can: slow down the checkout process; cause bottlenecks, especially in busy retail environments; and lead to staff errors (sometimes they forget to remove the spider wrap, and the alarm goes ON).

### D. Sales Impact

The combination of difficult handling, reduced product appeal, and checkout delays may actually reduce sales, especially in categories where product interaction matters (e.g., headphones, small electronics, etc.).

### E. False Alarms

The alarm can be overly sensitive and turn ON unnecessarily, either while being handled or by mistake. This can contribute to “alarm fatigue” where staff ignore real alerts because they're used to false ones.

### F. Requires Staff Involvement

Because they need cumbersome manual removal, spider wraps may require: training for staff, especially for newer employees; time during checkout or stocking; and increased labor costs for high-maintenance security.

### G. Limited Security

Determined thieves may still defeat spider wraps using cutters, magnets, or other tools, or even replace the packaging or swap barcodes to avoid detection, rendering the wrap ineffective.

The inventors herein have observed a need for alternatives for theft protection.

### II. SUMMARY

The disclosure below uses different embodiments to teach the broader principles with respect to articles of manufacture, apparatuses, processes for using the articles and apparatuses, processes for making the articles and apparatuses, and products produced by the process of making, along with necessary intermediates, directed to security, e.g., anti-theft protection.

This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

References cited herein are incorporated by reference as if fully stated herein, including U.S. Pat. No. 11,322,005. The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider an apparatus (method of making, method of using, products) including a combination such as a ratchet and a member configured to interact with a security device, such as a tag.

### III. INDUSTRIAL APPLICABILITY

Industrial applicability is representatively directed to that of apparatuses and devices, articles of manufacture, and processes of making and using them, in such as the manufacture of security equipment and parts thereof, e.g., for protection from theft.

### IV. FIGURES

FIG. 1 illustrates a perspective of an embodiment.

FIG. 2 illustrates a perspective of an embodiment.

FIG. 3 illustrates a perspective of an embodiment.

FIG. 4 illustrates a perspective of an embodiment.

FIG. 5 illustrates a perspective of an embodiment.

FIG. 6 illustrates a perspective of an embodiment.

FIG. 7 illustrates a perspective of components of an embodiment.

FIG. 8 illustrates a perspective of an embodiment.

FIG. 9 illustrates a perspective of an embodiment.

FIG. 10 illustrates a perspective of components of an embodiment.

FIG. 11 illustrates a perspective of an embodiment.

FIG. 12 illustrates a perspective of an embodiment.

### V. MODES

By way of an overview that is not intended to be limiting, consider the following components.

A ratchet is an apparatus such as a mechanical device that allows motion, typically continuous motion, in one direction, while preventing motion in the opposite direction, to keep a member in position temporarily. One type of ratchet includes a pawl engaging with gear teeth to allow unidirectional movement while preventing motion in the opposite direction.

An alternative is a friction-based ratchet, in which friction can function as a substitute for teeth, e.g., gear teeth and pawls. For example, a friction-based ratchet can use a rough surface or a set of friction pads that resist motion in one direction while allowing it in the other.

Another alternative is a cam mechanism, in which cam mechanisms (or cam-driven systems) are used instead of gears and pawls. For example, a cam mechanism can use a rotating cam with a specific profile that allows tightening a member in one direction, while the shape of the cam prevents reverse motion.

Yet another alternative is a tooth-and-spring mechanism (without a gear) that can include a set of teeth that interlock with a spring-loaded component, but not in the traditional gear and pawl arrangement. Instead, the teeth can be part of a surface or wheel, and the spring-loaded component could flex or slide to allow movement in one direction and prevent it in the opposite direction. In one configuration, the spring component can be arranged in such a way that it holds onto the teeth to resist backward motion while allowing forward motion. Thus, if the surface of a member has teeth on it, the spring will engage the teeth when moving a member in one direction, preventing motion in the reverse direction.

Still another alternative is interlocking teeth with a sliding lock (without a pawl), which can include teeth interlocking with a sliding mechanism that locks into place when movement is attempted in the reverse direction. For example, a set of teeth could work like a “comb” or a series of ridges. If the member is tightened past the mechanism, the teeth slide past one another, but the movement is backward, the teeth interlock and lock into place, blocking reverse motion.

Yet further, another alternative is a ratchet mechanism that can employ one or two sets of teeth angled in one direction that allows tightening but prevents movement in the opposite direction. This creates a self-locking mechanism using the angled teeth. Note that this mechanism can includes one or two sets of teeth that can be in a sawtooth pattern (or in other shape(s)). The teeth can be on a jaw or jaws positioned in such a way that, when tightening force is applied in one direction, the teeth allow tightening further. But when force is applied in the direction opposite to the tightening direction, the teeth of the jaw(s) engage to oppose movement in the opposite direction. Thus, if one tries to apply force in the opposite direction, the angled teeth bite to resist movement of a member. Accordingly, the teeth can have a structure and/or orientation or both that, when trying to move in the opposite direction, the teeth would either prevent further motion or create friction that resists the opposite movement. This would create a self-locking effect, with the teeth acting as the mechanism that resists moving a member in the opposite direction to the tightening direction yet allowing movement in the tightening direction.

Still an additional alternative is a unidirectional tightening mechanism, which can include at least one surface (or a portal, slot, or groove) that has teeth pointed in a tightening direction. As a member is tightened, the teeth allow the tightening process to proceed but prevent movement in the opposite direction. That is, when applying force to tighten the member, at least one end of the member moves past the teeth that prevents the member from loosening. For the member to be untightened, the member can be pulled all the way past the teeth. This means that the teeth prevent reverse motion while the tightening force is being applied and thereafter, but undoing or removing the member overcomes the engagement of the teeth. The teeth act like a one-way barrier that allows movement in the tightening direction, and the teeth prevent reverse movement, e.g., until the member is pulled through or out completely.

A further still alternative is a ratchet/belt prong system that includes a member, typically configured with teeth or a notched surface. The member being such as a belt, strap, or flexible material (like a webbing strap or leather belt) that has a series of teeth, grooves, holes, or notches along its length, like a toothed rack or notched surface. Also included is a pawl-like prong or locking lever that grabs the teeth or notches on the belt when tension is applied. When the member is tightened in one direction, the pawl (or prong) engages with teeth or notches on the member, creating a secure grip and preventing reverse motion. In some configurations, when tightening the member, the ratchet mechanism can apply pressure in the tightening direction, with the prong or pawl locking into the teeth or holes of the member. This can be in a manner analogous to how ratchet straps are used in cargo securement, where one continuously tightens a strap using a ratchet mechanism and the teeth on the strap prevent it from loosening. In any case, the ratchet ensures that once the desired tightness is reached, the pawl or prong effectively seizes the member and prevents reverse movement. To loosen or remove the member, one disengages the prong or pawl from the teeth of the member, e.g., by pressing a button, lifting a lever, or releasing the pawl so that the member can move freely.

A yet-additional alternative is a ratchet mechanism that includes a needle or pin that engages the member to hold it in place when or after tightening, and to loosen or remove the member, the pin is removed or retracted. The needle or pin can, but need not always, be configured to pierce the member when tightened and removed to untighten. In some forms of this mechanism, a needle or pin is driven into the member as part of the tightening process. The needle or pin has a sharp point and/or an expandable head that helps the needle or pin stay in place once the needle or pin pierces the member. The pin or needle is engaged with the member in such a way that there is collective resistance to any reverse motion-preventing the member from loosening. To untighten or remove the member, the ratchet mechanism retracts or removes the pin, allowing the member to return to its original position or be removed altogether.

From a broader perspective, there are a variety of ratchets—e.g., a ratchet can be a one-way ratchet, sprag ratchet, bearing ratchet, friction ratchet, pulling-only ratchet, or a seizing ratchet, and a variety of mechanisms to retard movement opposite the tightening direction of a member, e.g., teeth, ridges, cam, and/or friction, etc., and/or include at least one of a cleat, spike, angled strip, ball, cam, or clump—to allow tightening movement past the ratchet but limit or oppose movement opposite the tightening movement. Typically, such mechanisms apply force to keep the member in position temporarily and/or to maintain stability of the member.

Consider now a clamp, which has one or more surfaces, sometimes also known as “jaws,” that is/are adjustably positioned to hold a member in place and/or apply pressure to keep the member stationary and/or apply constant or uniform pressure to keep one or more objects (e.g., at least one end of a member) in a fixed position.

In some cases, a ratchet and a clamp can be separated. For example, as described above, the member can be drawn through a portal with or past teeth angled in the tightening direction, and elsewhere, a clamp can apply pressure on the member. In other cases, the ratchet can be combined with the jaw(s) of the clamp(s) that may, if desired, be an integral structure of the ratchet and clamp jaw. Also, if so desired, the ratchet and clamp jaw can be biased toward the member for the tightening. For support of a movable jaw that includes teeth emanating a member-contacting surface, on the opposite side of the member-contacting surface, there can be a buttress to connect a foot to the opposite side of the member-contacting surface, to collectively afford clamp support, e.g., when each jaw is swingably mounted into base.

Now consider a member, which in a mechanical context, refers to a structural component or piece that is part of a larger system or framework. That is, typically, a member is a part of a system. For example, one type of member is a load-bearing member is structured to support or one or more carry loads (e.g., tension, compression, bending) as part of an overall system, i.e., structure. These loads can be applied by external forces or internal stresses. Another one type of member is a member that provides connection to other parts or members to form a complete system. Yet another one type of member is a structural member, found in frameworks, such as beams, columns, or trusses, which carry loads and transfer one or more forces across a system. An additional one type of member is a machine member that is a part of a machine that interacts with other components to perform a specific function. These might include shafts, gears, linkages, or pistons. For example, a crankshaft in an engine or the links in a mechanical arm. Members can be rigid or flexible, in whole or part. A rigid member resists deformation and maintains a shape under load, such as a steel beam, whereas a flexible member can bend or stretch under load, such as a spring or cable.

In the context of some examples set out above, the member can be composed of an electrical insulator and a conductive area. The conductive area may, but need not, be adjacent to the electrical insulator. For example, the member can be a strip that is an electrical insulator, the conductive area can be adjacent to the electrical insulator, e.g., a tape with a conductive area can be applied to the electrical insulator. The tape can, if so desired, be such as is described in U.S. Pat. No. 11,322,005. The conductive area of the member can have a negative end and a positive end proximate one end of the member. As another example, the conductive area of the member can have a negative end proximate one end of the member and a positive end proximate an other end of the member. The member can, but need not always, be sufficiently flexible that, when fixed within the ratchet, the member can flex to form a loop. In such cases, the conductive area can be at least substantially exterior to the loop, or at least substantially interior to the loop, e.g., for securing an item within the loop. And if so desired, an area located at or near an end of the member can be shaped and/or textured differently than the strip sufficient to foster tightening the member in the ratchet. In some embodiments, the member can have a fastener on the end, e.g., an aglet can be located at or near an end of the member.

Note that the clamp or ratchet can provide or facilitate an electrical connection between a conductive area of the member and the security device. For example, there can be an electrically conductive façade adjacent to the movable jaw(s) and extending to a position for connection to the security device.

Like ratchets and clamps, there are a variety of members, e.g., they can vary in shape and size, depending on their function. They can be rods, beams, cables, tubes, cords, ribbons, plates, or shafts, and their dimensions are based on the required strength and function in the system, e.g., an electrical conductor, and a combination of an electrical conductor and an insulator.

Consider now a security device or tag that can provide power (e.g., from a battery) to at least one electrical circuit monitored to detect when an electrical connection is interrupted. The security device can be such as that in U.S. Pat. No. 11,322,005, modified if need be, to connect to a base containing the ratchet or modified to have the ratchet at a bottom of the security device. More generally, a security device is typically a tamper-resistant unit that can, but need not always, include an RFID chip, sensor, or both an RFID chip and sensor, at least one switch, an electrical circuit, and a power source (like a battery or capacitor).

An electrical circuit can include the security device connected to a conductive area or an electrifiable member, such as a conductive cable or wire, which can be wrapped around the consumer good, e.g., in one or more loops. An alarm mechanism, such as in U.S. Pat. No. 12,243,401, which is incorporated by reference as if fully stated herein, can be such that when the security device is activated (turned ON), the electrical circuit including the electrified member and the tag causes an alarm when the circuit is disrupted (e.g., if the member is cut or tampered with). That is, the security device detects the disruption and sends a signal to trigger an alarm.

There can be a connection system to form the circuit that the security device monitors. If the member is disturbed (cut, disconnected, or otherwise altered), and/or if the member is separated from the security device, the disruption in the circuit triggers the alarm system within the tag. The connection system may, but need not, include one or more clamps.

Illustratively, there can be a combination of the foregoing. The combination, for example, can include a security device, a ratchet, a member, and in some cases, a clamp. Using the combination can include tightening the member by rachet contact to provide physical security, and electrifying a conductive area of the member into circuitry of a security device for detecting tampering or theft, e.g., by alarming. So for example, the use can include electrically connecting security device circuitry to include a conductive area of a member, e.g., by tightening at least one end of the member through and past a ratchet, so as to allow tightening the member around a consumer good; and if so desired, securing the member with a clamp, e.g., to secure the conductive area into the electrical circuitry. In this manner, when the security device is activated, this system will trigger an alarm when the circuitry (including the conductive area) is disrupted, thereby protecting the consumer good from theft. That is, the system facilitates tightening the member by moving at least one end of the member partially through the ratchet for ratchet contact with the member.

From another point of view, a combination of the above can include electrifying a member or part thereof, e.g., a conductive strip, tape, cable, wire, etc.; the member can be strong enough to withstand tampering but flexible enough to engage with, or wrap around, different items, thusly engaging, ensnaring, or looping around the consumer good, so that the conductive area of the member is connected to circuitry of the security device. In some implementations, the electrified member can be a wire or an insulated wire, depending on the level of security needed. When the tag is activated, the member or conductive part thereof is electrified, completing an electrical circuit. In some embodiments, one end of the member is secured to a base or the security device, and in other embodiments, both ends are drawn into the ratchet.

Illustratively the use of the combination can include simultaneously engaging a ratchet that either clamps or separately engaging the ratchet and the clamp. In either case, the member including the conductive area can be releasably connectable and located for electrical communication with a security device. This system can be used in retail environments, for example, to protect high-value consumer goods (e.g., watches, jewelry, etc.), hard goods (e.g., electronics, tools, etc.), and soft goods (e.g., clothing, sheets, towels, etc. from theft.)

A ratchet or ratchet is used to tighten, or allow tightening, the electrifiable member with respect to the consumer good, e.g., by ensnaring or looking into or around the consumer good. The ratchet ensures that once the member is tightened, it stays secure in place and cannot easily be loosened. In some embodiments, the ratchet features a one-way locking mechanism that allows the user to tighten the electrifiable member by ratchet contact, e.g., after engaging, or looping the member around, the consumer good(s). Once the desired tension is reached, the ratchet locks the member in place, preventing loosening unless intentionally released, e.g., when the security device is turned Off or the alarm is disabled. After placing the electrifiable member around the consumer good (e.g., a pillow, sheet, comforter, towels, etc.), the user pulls or moves the member through the ratchet to tighten the electrifiable member past the ratchet, tightening the member with respect to the consumer good. The ratchet ensures that the member is tight enough to act as a secure barrier for preventing theft.

A clamp can be used to further secure the electrifiable member after it has been tightened through the ratchet. The clamp can help lock the electrifiable member in place. It may be a spring-loaded clamp or a locking clamp that holds the member firmly in position, preventing loosening the member after the tightening. The clamp can also cooperate with, or be used as, the connection system to engage and/or protect the electrical circuit, e.g., helping ensure that the member stays securely attached to the item and the tag, and also helping connect a conductive area or areas of the member into the electrical circuit. Depending on the embodiment, a clamp can be separated from, or part of, a ratchet mechanism. That is, clamping can also be done separately, or simultaneously with the ratcheting, depending on the embodiment. For example, after the member is tightened with ratchet contact, a clamp can be used to further secure the member and ensure that the conductive area(s) of the member are integrated into the circuit.

In an illustrative combination, an electrifiable member is wrapped around the consumer good(s) (e.g., a bath matt, tablecloth, quilt, etc.) and then the electrifiable member is connected to the security device to form a circuit, electrified by turning the security device ON. This can be done by a user who employes the ratchet when tightening the electrifiable member around the item(s). The tightening can be done by moving one or both ends of the electrifiable member past or through the ratchet to locate each conductive area of the member into position for electrification, e.g., by battery power from the security device.

Once tightened, the ratchet secures the member, ensuring against loosening through the ratchet unless releasing the ratchet. Activating the security device, or portion thereof that includes the conductive area of the member, can be such that as long as the circuit remains intact (i.e., the electrified conductive area of the member is not cut, disconnected, or otherwise tampered with, the security system remains silent and inactive. However, if an attempt is made to cut, tamper with, or remove the electrified member, or separate it from the circuit, the security device detects the break in the circuit and triggers an alarm. The alarm can be an audible sound or a signal to a monitoring system that alerts security or store personnel. In sum, this embodiment combines a security device with an electrifiable member (or portion thereof) that completes an electrical circuit. The member is tightened around the consumer good using a ratchet, and further secured by a clamp that may also electrically integrate the conductive area(s) of the member into the circuit. When the tag is turned ON, the circuit is closed, and any disruption (cutting the electrified member or portion thereof, disconnecting it, or disrupting operation of the security device, etc.) triggers an alarm. This system provides an enhanced level of security by combining physical deterrents with electrical monitoring to prevent theft in retail environments.

In another perspective, the use can include locating at least one end of a member, or conductive potion thereof, in or past a ratchet located to hold by ratchet contact with the member or portion, after an end of the member has been tightened beyond the ratchet and into a position where a conductive area of the member is engaged into an electrical circuit. The electrical circuit extends to a security device that includes a battery location and an alarm triggered by disruption of the electrical circuit.

Similarly, there can be a ratchet is located to hold the member by ratchet contact with the member after a second end of the member has been tightened beyond the ratchet, e.g., both ends of the member are tightened simultaneously in some embodiments, and in other embodiments, one end of the member is secured or securable with respect to the security device, and the other end of the member is ratcheted by the ratchet contact.

In some embodiments, a base can include at least one extension or protrusion, and each jaw can include a lip that releasably secures the lip to the at least one extension or protrusion when said each jaw is in a closed position. This extension or protrusion is different from an extension or protrusion perpendicular to the first surface of the jaw that can be used to releasably limit member movement when the member is within said jaw, e.g., a pin as this type of extension or protrusion.

Note that the ratchet can be a component at the bottom of the security device or be a component of a base that is releasably attachable to the security device or a midsection of the security device. In some configurations, the releasably attachable base can be joined or secured with respect to the security device to allow the member to be tightened, and the security device and base can be openable or separable, to release the member. For example, the ratchet can be connected to a base that is releasably connectable to a portion of the security device and to the electrical circuit and that, when joined to the base, the security device secures positioning of each said jaw prior to the member being tightened.

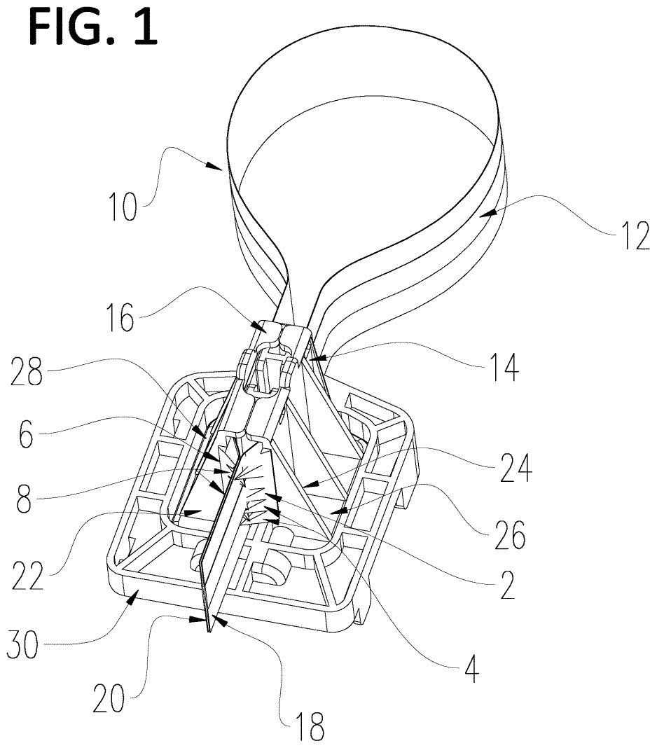

Turn now to FIG. 1, which illustrates at least one ratchet 2 that in this, but not every, embodiment, has teeth 4. Similarly in this embodiment, there is a second ratchet 6 that has also has teeth 8. The ratchets 2 and 4 are in ratchet contact with member 10 which can, but need not, be an insulator with a conductive area 12. Member 10 can be interchangeable with another member 10 of a different length or composition.

In the example illustrated in FIG. 1, the ratchet 2 is on clamp jaw 14, and ratchet 4 is on clamp jaw 16. The member 10 has at least one end 18 and, if so desired, a second end 20, each of which in this case are tightened past the ratchets 2 and 4. Respectively, each clamp jaw 14 and 16 is supported by at least one buttress 22 and, if so desired, butress 24, each of which is in turn connected to a foot 26 and 28. Also respectively, each clamp jaw 14 and 16 is rotatively or swingably mounted to a base 30. Base 30 can in some embodiments be detatchably attached to a security device or part thereof, or base 30 can be a bottom of the security device or part thereof.

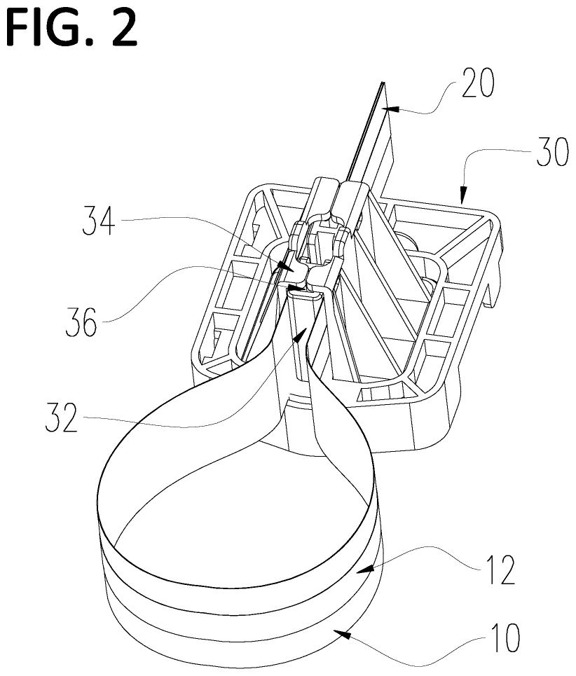

At least one of the clamp jaws 14 and 16 can be engaged in a closed position. For example, FIG. 2 illustrates that there can be at least one stanchion 32 against which at least one of the clamp jaws 14 and 16, when in a closed position, can compress the member 10. The clamp jaw(s) 14 and/or 16 can have support 34 for at least one denticulation (not shown in FIG. 2) that engages with a receptacle 36 of stanchion 32.

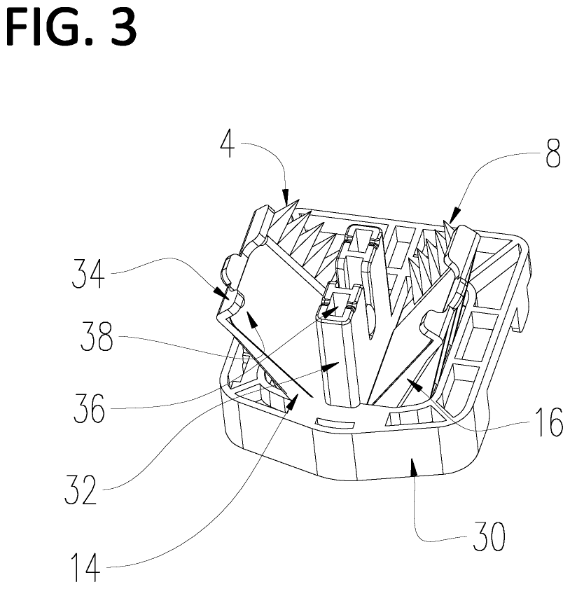

In contrast to FIGS. 1 and 2, which illustrate clamp jaw(s) 14 and/or 16 in a closed position, FIG. 3 shows the clamp jaws 14 and/or 16 in an open position. Stanchion 32 and its receptacle 36 can be seen disengaged from a denticulation 38.

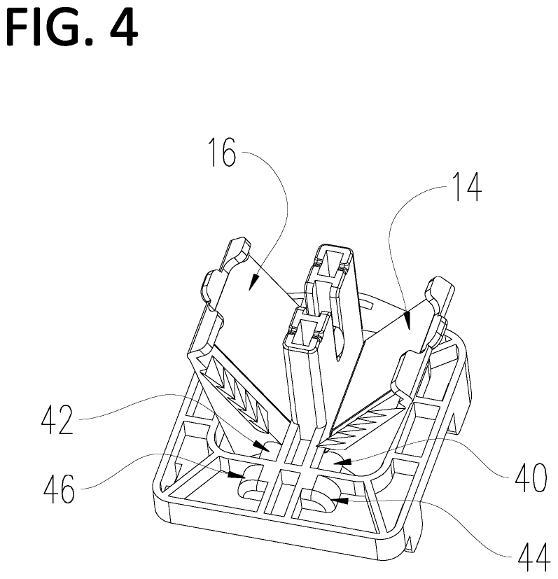

As previously mentioned, each clamp jaw 14 and 16 can be rotatively or swingably mounted to a base 30. For example, in FIG. 4, each clamp jaw 14 and 16 can be respectively have a nubs or axels 40 and 42 that are rotatable or swingable within such as a sleeve or partial sleeve 46 and 48.

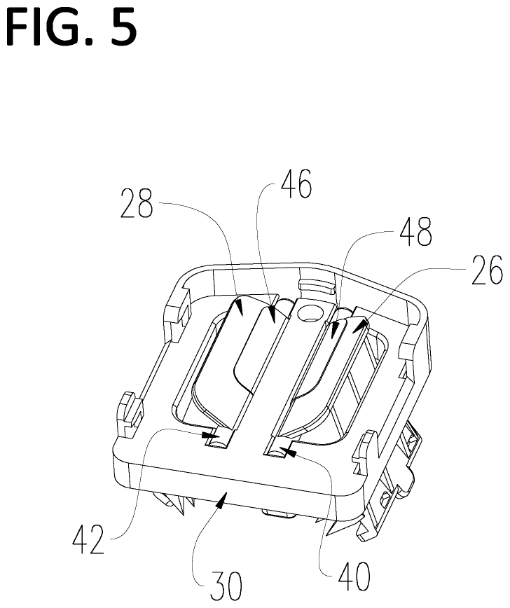

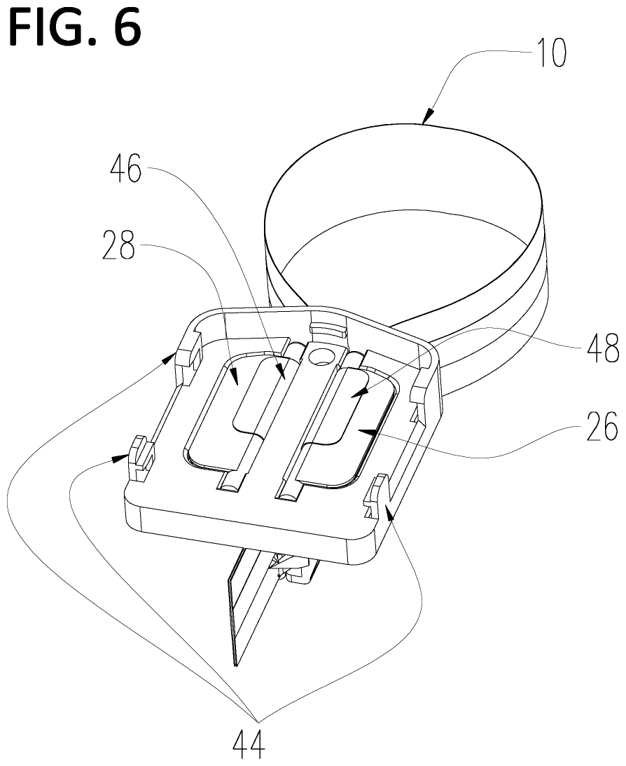

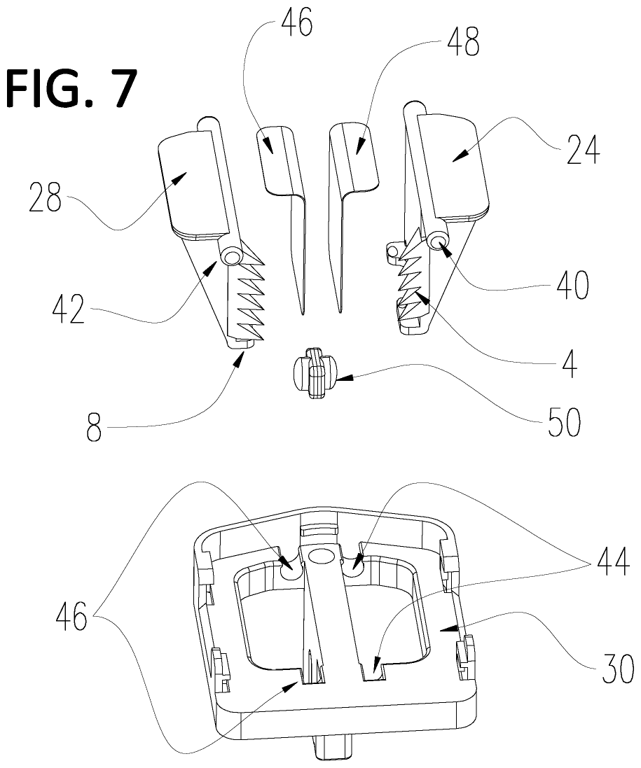

FIGS. 5 and 6 illustrate a member 30 distal, security device proximate view that includes base 30. If so desired, the base can asymmetrically indicate, e.g., by pointing, a direction from which the member 10 can be inserted. Base 30 can also have pieces 44 for aligning and/or releasably securing base 30 with a security device or part thereof, as illustrated and elaborated below. FIG. 5 shows the open position of the foot 26 and 28, corresponding to the open position of each clamp jaw 14 and 16, which can be compared with FIG. 6, which shows the closed position of the foot 26 and 28, corresponding to the open position of each clamp jaw 14 and 16 after ends of member 10 has been tightened. There are various ways to form an electrical connection linking the conductive area 12 with the security device, including by having one or more electrically conductive façades 46 and 48 respectively for each of the clamp jaws 14 and 16. FIG. 7 provides an assembly view of the electrically conductive façades 46 and 48 for the clamp jaws 14 and 16, along with a biasing member 50 (for such as biasing the clamp(s). The biasing member 50 can be located to dispose the clamp jaws 14 and 16, e.g., in an open position until receptacle 36/denticulation 38 engagement. That is, biasing member 50 can provide a means by which the ratchet 2 is biased to clamp the member 10.

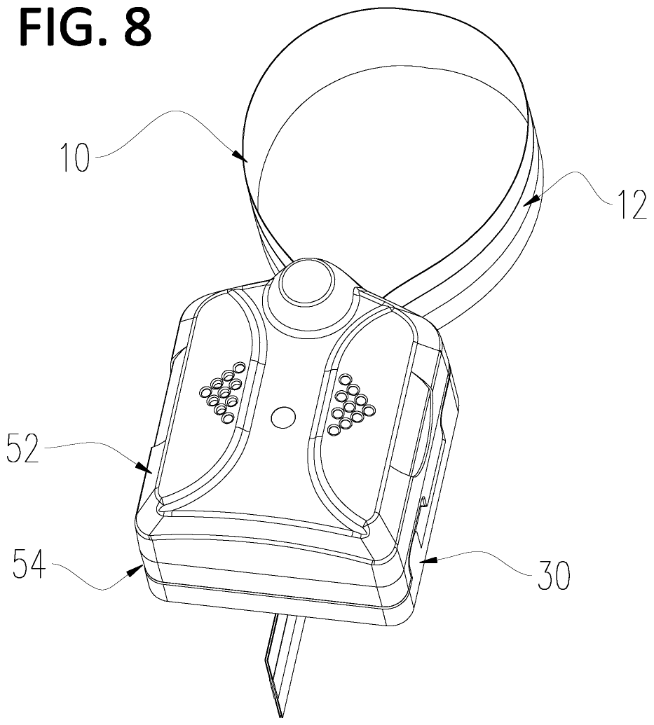

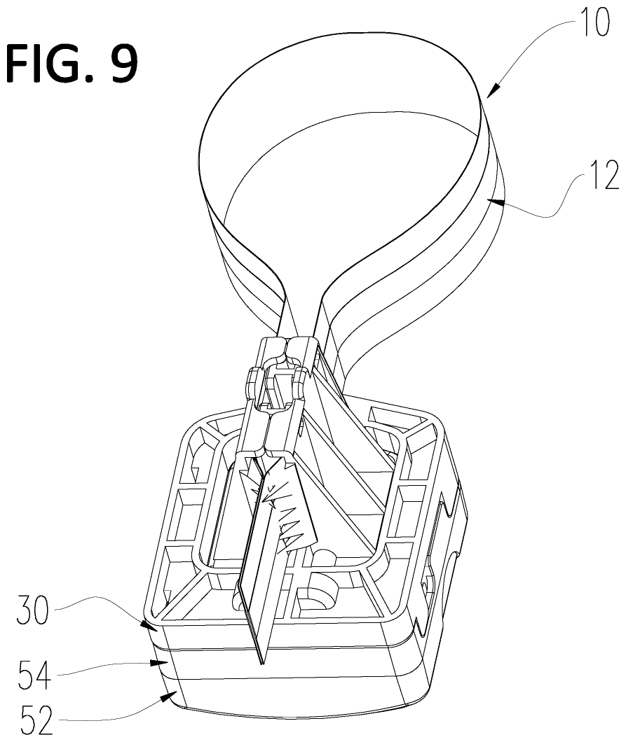

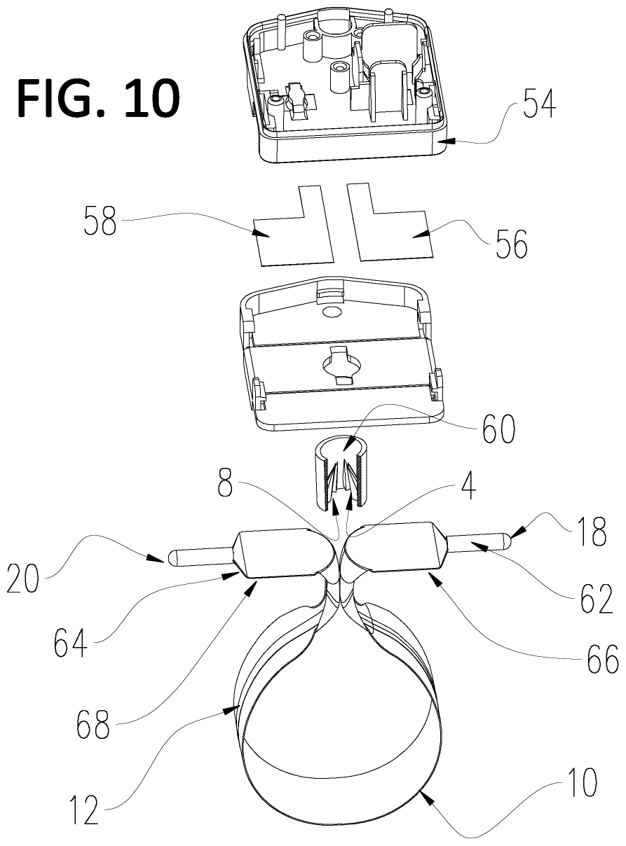

FIGS. 8 and 9 illustrate the base 30 embodiment in connection with security device 52. There can, but need not, be an intermediate level 54 (such as base 54 in U.S. Pat. No. 11,322,005) to which base 30 is releasably detachable. Security device 52 can be modified from what is disclosed in U.S. Pat. No. 11,322,005 to provide electrical connection through to the conductive area 12 of member 10, as discussed above. For example, in U.S. Pat. No. 11,322,005, such as its alarm device 22 portion, can be configured to connected to base 30 (instead of cradle 4 of U.S. Pat. No. 11,322,005), as illustrated in FIG. 10. Intermediate level 54 can extend electrical connection to negative clamp face 56 and positive clamp face 58, each of which is electrically conductive. When pulled through portal 60 and past at least one tooth or set of teeth 4 and/or 8 that form a ratchet 2, member 10 encounters the clamp faces 56 and 58, which can be disposed to compress against member 10 to help secure electrical connection with circuitry of the security device 22. Mounting the security device 52 or intermediate section 54 can be configured to secure closed positions of the negative clamp face 56 and/or the positive clamp face 58, or in other embodiments, clamp(s) 14 and/or 16, e.g., prior to, or after, the member 10 has been tightened beyond the ratchet 2 and openable to release the member 10. In this configuration, the conductive area 12 is internal to a loop formed by the ends 18 and 20 tightened past the ratchet 2. The ends 18 and 20 can, if so desired, be incorporated with aglet 62 and aglet 64 and/or pull tabs 64 and 68. The member 10 can be removed from this combination by pulling member 10 completely through the ratchet 2, etc. This in some embodiments, the ratchet 2 is at a releasably attachable base 30 of the security device 52 or midsection 54, and the ratchet 2 is in a position secured by attachment to the security device 52 or midsection 54, e.g., prior to the member having been tightened beyond the ratchet 2, and is in an openable position to release the member 10 when the releasably attachable base 30 is released from the security device 52 or midsection 52.

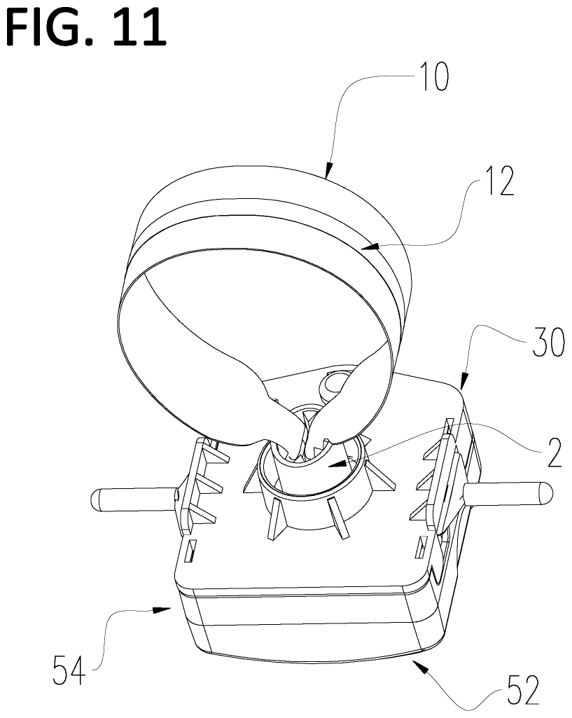

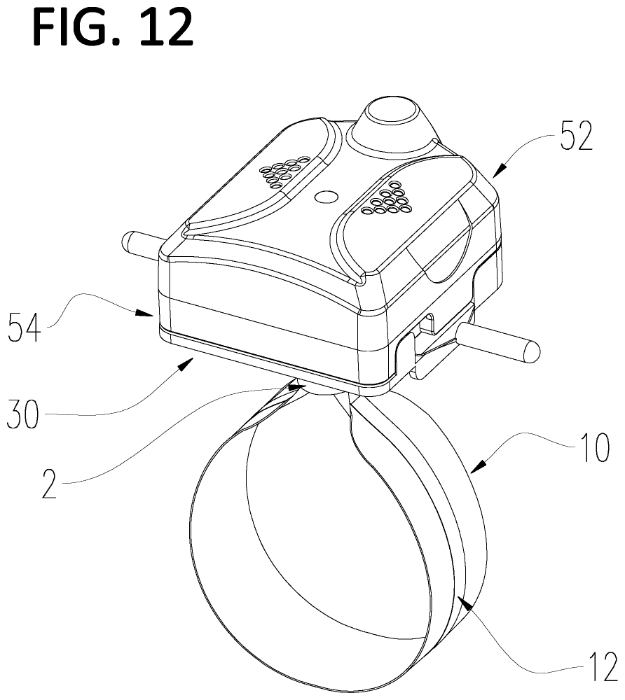

FIGS. 11 and 12 illustrate perspectives of an embodiment, which in a manner of thinking, exemplify that a ratchet 2 and member 10 in combination with a security device 52 can be in a number of combinations, depending on the embodiment(s) of interest—the different elaborated embodiments herein showing the broader principles with respect to articles of manufacture, apparatuses, processes for using the articles and apparatuses, processes for making the articles and apparatuses, and products produced by the process of making, along with necessary intermediates, directed to security, e.g., anti-theft protection.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. An apparatus including:
a ratchet located to hold a member by ratchet contact with the member, after an end of the member has been tightened beyond the ratchet and into a position where a conductive area of the member is engaged into an electrical circuit extending to a security device that comprises a battery location and an alarm triggered by disruption of the electrical circuit.

2. The apparatus of claim 1, wherein the ratchet is a one-way ratchet.

3. The apparatus of claim 1, wherein the ratchet comprises teeth.

4. The apparatus of claim 1, wherein the ratchet comprises ridges.

5. The apparatus of claim 1, wherein the ratchet comprises at least one pin.

6. The apparatus of claim 1, wherein the ratchet is a sprag ratchet, a one-way bearing ratchet, a friction ratchet, a pulling-only ratchet, or a seizing ratchet.

7. The apparatus of claim 1, wherein the ratchet is located to hold the member by ratchet contact with the member, after a second end of the member has been tightened beyond the ratchet.

8. The apparatus of claim 1, wherein the ratchet comprises a portal.

9. The apparatus of claim 1, wherein the ratchet is biased to clamp the member.

10. The apparatus of claim 1, further comprising clamp to secure the conductive area into the electrical circuit.

11. The apparatus of claim 1, wherein the ratchet comprises at least one movable jaw.

12. The apparatus of claim 1, wherein the ratchet comprises at least one movable jaw and is biased to clamp the member.

13. The apparatus of claim 11, further including an electrically conductive façade adjacent each said at least one movable jaw and extending to a position for connection to the security device.

14. The apparatus of claim 13, wherein each said at least one movable jaw comprises teeth emanating from a side of a first surface, a foot on a second side of the first surface, and a buttress connecting the foot to the second side.

15. The apparatus of claim 14, further comprising a base into which each said jaw is swingably mounted.

16. The apparatus of claim 15, wherein the base comprises at least one stanchion having a receptacle that is engagably disengagable from at least one denticulation on a lip of a jaw.

17. The apparatus of claim 15, wherein said jaw includes a stanchion that releasably limits member movement when the member is within said jaw.

18. The apparatus of claim 1, wherein the member comprises an electrical insulator, and said conductive area is adjacent to the electrical insulator.

19. The apparatus of claim 1, wherein the member comprises a strip that is an electrical insulator, said conductive area is adjacent to the electrical insulator, and an area located at or near an end of the member is shaped and/or textured different than the strip sufficient to foster tightening the member in the ratchet.

20. The apparatus of claim 1, wherein the member comprises a strip that is an electrical insulator, said conductive area is adjacent to the electrical insulator, and an aglet located at or near an end of the member.

21. The apparatus of claim 1, wherein the member, when fixed within the ratchet, forms a loop.

22. The apparatus of claim 1, wherein the member, when fixed within the ratchet forms a loop with the conductive area at least substantially interior to the loop.

23. The apparatus of claim 1, wherein the member, when fixed within the ratchet forms a loop with the conductive area at least substantially exterior to the loop.

24. The apparatus of claim 1, wherein the ratchet is at a bottom of the security device.

25. The apparatus of claim 1, wherein the ratchet is at a releasably attachable base of the security device.

26. The apparatus of claim 1, wherein the ratchet is at a releasably attachable base of a releasably detachable midsection of the security device.

27. The apparatus of claim 3, wherein the ratchet is at a releasably attachable base of a releasably detachable midsection of the security device.

28. The apparatus of claim 1, wherein the ratchet is at a releasably attachable base of the security device, and the ratchet is in a position secured by attachment to the security device prior to the member having been tightened beyond the ratchet and is in an openable position to release the member when the releasably attachable base is released from the security device.

29. The apparatus of claim 1, wherein the member has a length and is interchangeable with another member of a different length.

30. The apparatus of claim 1, wherein the ratchet is connected to a base that is releasably connectable to a portion of the security device and to the electrical circuit.

31. A method comprising:
tightening an end of a member to a position beyond a ratchet;
engaging the ratchet with the member to hold the member in place with ratchet contact after the tightening; and
releasably locating a conductive area of the member to integrate into a circuit of a security device comprising a battery and an alarm and thereby, when the security device is ON, trigger the alarm when the circuit comprising the conductive area of the member is disrupted.
